(19) United States
(12) Patent Application Publication
(10) Pub. No.: US 2026/0024492 A1
(43) Pub. Date: Jan. 22, 2026

(54) DISPLAY DEVICE AND ELECTRONIC DEVICE INCLUDING THE SAME

(71) Applicant: Samsung Display Co., Ltd., Yongin-si (KR)

(72) Inventors: HYONGDO CHOI, Yongin-si (KR); YOON-HO KIM, Yongin-si (KR)

(21) Appl. No.: 19/196,563

(22) Filed: May 1, 2025

(30) Foreign Application Priority Data
Jul. 19, 2024 (KR) 10-2024-0095868

(51) Int. Cl. G09G 3/3233; G09G 3/32

(52) U.S. Cl. CPC G09G 3/3233; G09G 3/32; G09G 2300/0819; G09G 2300/0842; G09G 2310/08; G09G 2330/021

(57) ABSTRACT

A display device includes: a display panel including a pixel to receive a driving voltage through a driving voltage line; a panel driver to drive the display panel; a voltage generator to generate the driving voltage, and determine a voltage level of the driving voltage based on a voltage control signal; a driving controller to control a driving of the panel driver, and supply the voltage control signal to the voltage generator; and a voltage detector between the voltage generator and the driving voltage line, and to sense a sensing voltage corresponding to a current flowing into the driving voltage line, and output a sensing signal based on the sensing voltage. The driving controller is to: receive the sensing signal from the voltage detector; and generate the voltage control signal based on the sensing signal.

### CROSS-REFERENCE TO RELATED APPLICATION

The present application claims priority to and the benefit of Korean Patent Application No. 10-2024-0095868, filed on Jul. 19, 2024, in the Korean Intellectual Property Office, the entire disclosure of which is incorporated by reference herein.

### BACKGROUND

### 1. Field

Aspects of embodiments of the present disclosure relate to a display device capable of reducing a power consumption, and an electronic device including the display device.

### 2. Description of the Related Art

A light emitting display device from among various kinds of display devices displays an image by using a light emitting diode that generates light through recombination of electrons and holes. The light emitting display device may be driven with low power, while providing fast response speeds.

The light emitting display device includes a display panel on which pixels connected to data lines and scan lines are disposed. Each of the pixels generally includes a light emitting diode, and a pixel circuit unit (e.g., a pixel circuit) for controlling an amount of current flowing to the light emitting diode. The pixel circuit unit controls the amount of current flowing through the light emitting diode in response to a data signal. In this case, light of a desired luminance (e.g., a predetermined luminance) is generated to correspond to the amount of current flowing through the light emitting diode.

The above information disclosed in this Background section is for enhancement of understanding of the background of the present disclosure, and therefore, it may contain information that does not constitute prior art.

### SUMMARY

Embodiments of the present disclosure may be directed to a display device capable of reducing a power consumption, and an electronic device including the display device.

According to one or more embodiments of the present disclosure, a display device includes: a display panel including a pixel configured to receive a driving voltage through a driving voltage line; a panel driver configured to drive the display panel; a voltage generator configured to generate the driving voltage, and determine a voltage level of the driving voltage based on a voltage control signal; a driving controller configured to control a driving of the panel driver, and supply the voltage control signal to the voltage generator; and a voltage detector between the voltage generator and the driving voltage line, and configured to sense a sensing voltage corresponding to a current flowing into the driving voltage line, and output a sensing signal based on the sensing voltage. The driving controller is configured to: receive the sensing signal from the voltage detector; and generate the voltage control signal based on the sensing signal.

In an embodiment, the driving controller may include: a comparator configured to select a reference driving voltage corresponding to the sensing signal from a look-up table configured to store a plurality of reference driving voltages corresponding to a plurality of reference signals, respectively; and a controller configured to adjust the voltage control signal to control the driving voltage to have a voltage level corresponding to the reference driving voltage.

In an embodiment, the voltage detector may include: a detection circuit including a sensing resistor connected between the voltage generator and the driving voltage line; an amplification circuit connected to a first end of the sensing resistor and a second end of the sensing resistor, and configured to output an output voltage by amplifying a sensing voltage sensed through the first end; a gain control circuit configured to control a gain of the amplification circuit; and a conversion circuit configured to receive the output voltage from the amplification circuit, and convert the output voltage into the sensing signal.

In an embodiment, the amplification circuit may include: an operational amplifier including a first terminal connected to the first end, and a second terminal connected to the second end; and a transistor including an input electrode connected to the first end, a control electrode connected to an output terminal of the operational amplifier, and an output electrode connected to an output terminal of the amplification circuit.

In an embodiment, the gain control circuit may include a gain adjustment resistor connected between the output terminal of the amplification circuit and a ground terminal configured to receive a ground voltage.

In an embodiment, the gain control circuit may be configured to: receive a gain control signal from the driving controller; and control the gain of the amplification circuit in response to the gain control signal.

In an embodiment, the conversion circuit may include an analog-to-digital converter configured to convert the output voltage into the sensing signal as a digital signal, and the comparator may be configured to receive the sensing signal from the conversion circuit.

In an embodiment, the voltage control signal may be a square wave signal, and the controller may be configured to adjust a duty ratio of the voltage control signal to control the driving voltage to have a voltage level corresponding to the reference driving voltage.

In an embodiment, the driving voltage line may include at least one of a first driving voltage line or a second driving voltage line, and the pixel may include: a driving transistor connected to the first driving voltage line configured to receive a first driving voltage; and a light emitting element connected between the driving transistor and the second driving voltage line configured to receive a second driving voltage.

In an embodiment, the voltage detector may be connected between the voltage generator and the second driving voltage line as the driving voltage line.

According to one or more embodiments of the present disclosure, a display device includes: a display panel including a pixel configured to receive a driving voltage through a driving voltage line; a panel driver configured to drive the display panel; a voltage generator configured to generate the driving voltage, and determine a voltage level of the driving voltage based on a voltage control signal; a driving controller configured to control a driving of the panel driver; and a voltage controller between the voltage generator and the driving voltage line, and configured to sense a sensing voltage corresponding to a current flowing into the driving voltage line, and generate the voltage control signal based on the sensing voltage.

In an embodiment, the voltage controller may include: a detection circuit including a sensing resistor connected between the voltage generator and the driving voltage line; an amplification circuit connected to a first end of the sensing resistor and a second end of the sensing resistor, and configured to amplify a sensing voltage sensed through the first end into an amplification sensing voltage; a gain control circuit configured to control a gain of the amplification circuit; a conversion circuit configured to convert the amplification sensing voltage into a sensing signal; and a controller configured to: receive the sensing signal; select a reference driving voltage corresponding to the sensing signal from a look-up table configured to store a plurality of reference driving voltages corresponding to a plurality of reference signals, respectively; and adjust the voltage control signal to control the driving voltage to have a voltage level corresponding to the reference driving voltage.

In an embodiment, the conversion circuit and the controller may be embedded together in a voltage control chip.

In an embodiment, the amplification circuit may include: an operational amplifier including a first input terminal connected to the first end, and a second input terminal connected to the second end; and a transistor including an input electrode connected to the first end, a control electrode connected to an output end of the operational amplifier, and an output electrode connected to an output end of the amplification circuit.

In an embodiment, the gain control circuit may include a resistor connected between the output end of the amplification circuit and a ground end configured to receive a ground voltage.

In an embodiment, the gain control circuit may be configured to: receive a gain control signal from the driving controller; and control the gain of the amplification circuit in response to the gain control signal.

In an embodiment, the conversion circuit may include an analog-to-digital converter configured to convert the amplification sensing voltage into the sensing signal as a digital signal, and the controller may be configured to receive the sensing signal from the conversion circuit.

In an embodiment, the voltage control signal may be a square wave signal, and the controller may be configured to adjust a duty ratio of the voltage control signal to control the driving voltage to have a voltage level corresponding to the reference driving voltage.

In an embodiment, the driving voltage line may include at least one of a first driving voltage line or a second driving voltage line. The pixel may include: a driving transistor connected to the first driving voltage line configured to receive a first driving voltage; and a light emitting element connected between the driving transistor and the second driving voltage line configured to receive a second driving voltage. The driving voltage may be one of the first driving voltage or the second driving voltage, and the voltage controller may be connected between the voltage generator and the second driving voltage line.

According to one or more embodiments of the present disclosure, an electronic device includes: a display panel including a pixel configured to receive a driving voltage through a driving voltage line; a panel driver configured to drive the display panel; a voltage generator configured to generate the driving voltage, and determine a voltage level of the driving voltage based on a voltage control signal; a driving controller configured to control a driving of the panel driver, and supply the voltage control signal to the voltage generator; a voltage detector between the voltage generator and the driving voltage line, and configured to sense a sensing voltage corresponding to a current flowing into the driving voltage line, and output a sensing signal based on the sensing voltage; and a main processor configured to provide an image signal to the driving controller. The driving controller is configured to: receive the sensing signal from the voltage detector; and generate the voltage control signal based on the sensing signal.

However, the present disclosure is not limited to the above aspects and features, and the above and additional aspects and features will be set forth, in part, in the detailed description that follows with reference to the drawings, and in part, may be apparent therefrom, or may be learned by practicing one or more of the presented embodiments of the present disclosure.

### BRIEF DESCRIPTION OF THE DRAWINGS

The above and other aspects and features of the present disclosure will be more clearly understood from the following detailed description of the illustrative, non-limiting embodiments with reference to the accompanying drawings.

FIG. 1 is a perspective view of a display device, according to an embodiment of the present disclosure.

FIG. 2 is an exploded perspective view of a display device, according to an embodiment of the present disclosure.

FIG. 3 is a block diagram of a display device, according to an embodiment of the present disclosure.

FIG. 4A is an equivalent circuit diagram illustrating a pixel, according to an embodiment of the present disclosure.

FIG. 4B is a waveform diagram illustrating an operation of the pixel shown in FIG. 4A in a sensing period.

FIG. 5A is a block diagram showing a voltage detector, according to an embodiment of the present disclosure.

FIG. 5B is a block diagram of a driving controller, according to an embodiment of the present disclosure.

FIGS. 6A and 6B are tables showing a power consumption reduction depending on a luminance and an occupancy rate by a voltage detector, according to some embodiments of the present disclosure.

FIG. 7 is a block diagram showing a voltage detector, according to an embodiment of the present disclosure.

FIG. 8 is a block diagram of a display device, according to an embodiment of the present disclosure.

FIG. 9 is a block diagram showing a voltage controller, according to an embodiment of the present disclosure.

FIG. 10 is a block diagram showing a voltage controller, according to an embodiment of the present disclosure.

FIG. 11 is a plan view of a display device, according to an embodiment of the present disclosure.

FIG. 12 is a block diagram of an electronic device, according to an embodiment of the present disclosure.

### DETAILED DESCRIPTION

Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

When a certain embodiment may be implemented differently, a specific process order may be different from the described order. For example, two consecutively described processes may be performed at the same or substantially at the same time, or may be performed in an order opposite to the described order.

Further, as would be understood by a person having ordinary skill in the art, in view of the present disclosure in its entirety, each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner, unless otherwise stated or implied.

In the drawings, the relative sizes, thicknesses, and ratios of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

Further, it should be expected that the shapes shown in the figures may vary in practice depending, for example, on tolerances and/or manufacturing techniques. Accordingly, the embodiments of the present disclosure should not be construed as being limited to the specific shapes shown in the figures, and should be construed considering changes in shapes that may occur, for example, as a result of manufacturing. As such, the shapes shown in the drawings may not depict the actual shapes of areas of the device, and the present disclosure is not limited thereto.

In the figures, the x-axis, the y-axis, and the z-axis are not limited to three axes of the rectangular coordinate system, and may be interpreted in a broader sense. For example, the x-axis, the y-axis, and the z-axis may be perpendicular to or substantially perpendicular to one another, or may represent different directions from each other that are not perpendicular to one another.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “on,” “connected to,” or “coupled to” another element or layer, it can be directly on, connected to, or coupled to the other element or layer, or one or more intervening elements or layers may be present. Similarly, when a layer, an area, or an element is referred to as being “electrically connected” to another layer, area, or element, it may be directly electrically connected to the other layer, area, or element, and/or may be indirectly electrically connected with one or more intervening layers, areas, or elements therebetween. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, the expression “A and/or B” denotes A, B, or A and B. Expressions such as “at least one of,” when preceding a list of elements, modify the entire list of elements and do not modify the individual elements of the list. For example, the expression “at least one of a, b, or c,” “at least one of a, b, and c,” and “at least one selected from the group consisting of a, b, and c” indicates only a, only b, only c, both a and b, both a and c, both b and c, all of a, b, and c, or variations thereof.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

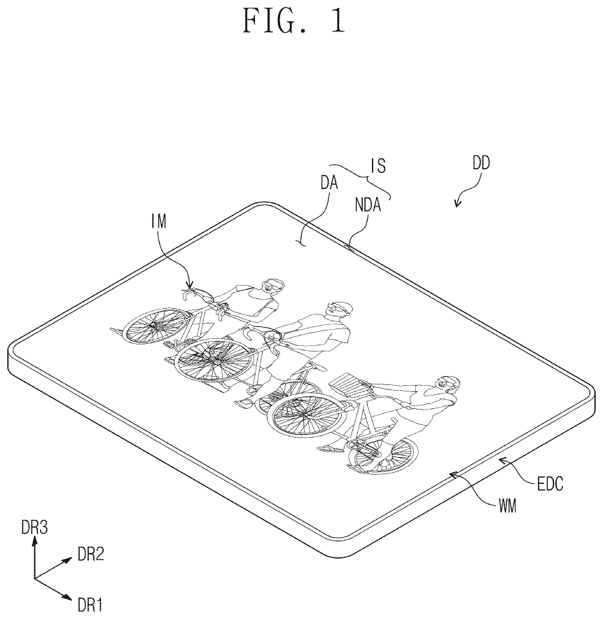

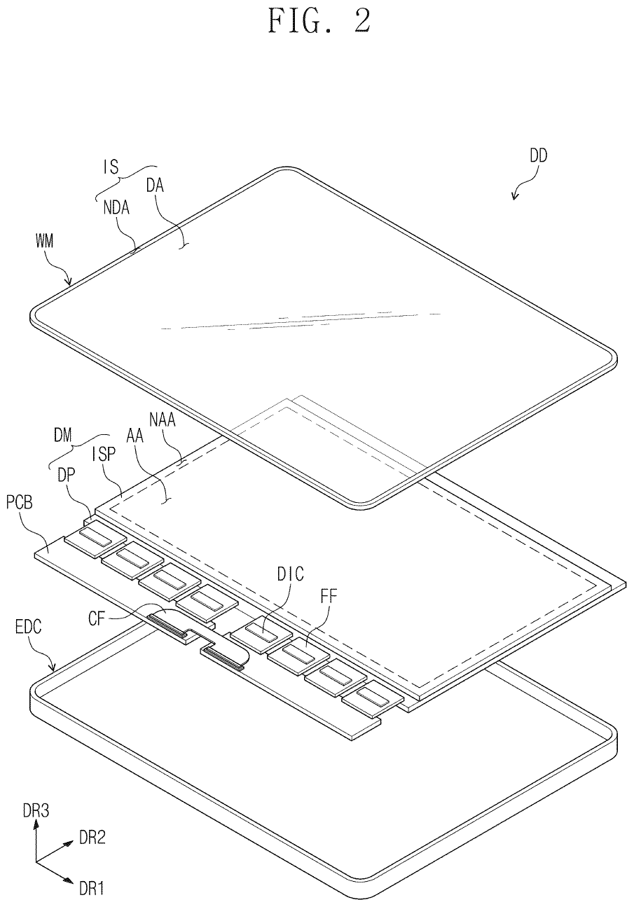

FIG. 1 is a perspective view of a display device, according to an embodiment of the present disclosure. FIG. 2 is an exploded perspective view of a display device, according to an embodiment of the present disclosure.

Referring to FIGS. 1 and 2, a display device DD may be a device that is activated depending on an electrical signal. The display device DD according to some embodiments of the present disclosure may be a small-sized or medium-sized electronic device, such as a mobile phone, a tablet PC, a notebook computer, a vehicle navigation system, or a game console. In some embodiments, the display device DD may be a large-sized electronic device, such as a television or a monitor. However, the present disclosure is not limited thereto, and the display device DD may be implemented as another suitable kind of electronic device including a display or a display device. The display device DD has a rectangular shape including a long side extending in a first direction DR1, and a short side extending in a second direction DR2 intersecting or crossing the first direction DR1. However, the shape of the display device DD is not limited thereto. For example, the display device DD may be implemented in various suitable shapes. The display device DD may display an image IM on a display surface IS parallel to or substantially parallel to each of the first direction DR1 and the second direction DR2, so as to face a third direction DR3. The display surface IS on which the image IM is displayed may correspond to a front surface of the display device DD.

In an embodiment, a front surface (e.g., an upper/top surface) and a rear surface (e.g., a lower/bottom surface) of each member may be defined based on a direction in which the image IM is displayed (e.g., the third direction DR3). The front surface may be opposite to the rear surface in the third direction DR3, and a normal direction of each of the front surface and the rear surface may be parallel to or substantially parallel to the third direction DR3.

A separation distance between the front surface and the rear surface in the third direction DR3 may correspond to a thickness of the display device DD in the third direction DR3. However, the directions that the first, second, and third directions DR1, DR2, and DR3 in the figures indicate may be relative concepts, and may be variously modified to different relative directions as needed or desired.

The display device DD may sense an external input applied from the outside. The external input may include various suitable kinds of inputs that are provided from the outside of the display device DD. The display device DD according to an embodiment of the present disclosure may sense an external input of a user, which is applied from the outside. The external input of the user may be one of various suitable kinds of external inputs, such as a part of his/her body, his/her gaze, light, heat, pressure, or a suitable combination thereof. Also, the display device DD may sense the external input of the user applied to a side surface or a rear surface of the display device DD depending on a desired structure of the display device DD, and is not particularly limited. As an example, an external input may include an input entered through an input device (e.g., a stylus pen, an active pen, a touch pen, an electronic pen, or an E-pen).

The display surface IS of the display device DD may be divided into a display area DA and a non-display area NDA. The display area DA may be an area in which the image IM is displayed. A user perceives (e.g., views) the image IM through the display area DA. In an embodiment, the display area DA is illustrated in the shape of a quadrangle having vertexes that are rounded. However, the present disclosure is not limited thereto. The display area DA may have various suitable shapes, and is not particularly limited.

The non-display area NDA is adjacent to the display area DA. The non-display area NDA may have a desired color (e.g., a given or predetermined color). The non-display area NDA may surround (e.g., around a periphery of) the display area DA. Accordingly, a shape of the display area DA may be defined substantially by the non-display area NDA. However, the present disclosure is not limited thereto. The non-display area NDA may be positioned to be adjacent to one side (e.g., to only one side) of the display area DA, or may be omitted as needed or desired. The display device DD according to the present disclosure may be variously modified as needed or desired, and is not particularly limited.

Referring to FIG. 2, the display device DD may include a display module (e.g., a display or a touch-display) DM, and a window WM disposed on the display module DM. The display module DM may include a display panel DP and an input sensing layer ISP.

According to an embodiment of the present disclosure, the display panel DP may include a light emitting display panel. For example, the display panel DP may be an organic light emitting display panel, an inorganic light emitting display panel, or a quantum dot light emitting display panel. A light emitting layer of the organic light emitting display panel may include an organic luminescent material. A light emitting layer of the inorganic light emitting display panel may include an inorganic luminescent material. A light emitting layer of the quantum dot light emitting display panel may include a quantum dot, a quantum rod, or the like.

The display panel DP may output the image IM, and thus, the image IM may be displayed through the display surface IS.

The input sensing layer ISP may be disposed on the display panel DP to sense the external input. The input sensing layer ISP may be directly disposed on the display panel DP. According to an embodiment of the present disclosure, the input sensing layer ISP may be formed on the display panel DP by a subsequent process. In other words, when the input sensing layer ISP is directly disposed on the display panel DP, an inner adhesive film may not be interposed between the input sensing layer ISP and the display panel DP. However, the present disclosure is not limited thereto, and the inner adhesive film may be interposed between the input sensing layer ISP and the display panel DP. In this case, the input sensing layer ISP may not be manufactured by a process continuous to that of the display panel DP. In other words, the input sensing layer ISP may be manufactured through a process separate from that of the display panel DP, and may then be fixed on an upper surface of the display panel DP by the inner adhesive film.

The window WM may be formed of a transparent material capable of outputting the image IM. For example, the window WM may be formed of glass, sapphire, plastic, or the like. While FIG. 2 illustrates that the window WM is implemented with a single layer, the present disclosure is not limited thereto. For example, the window WM may include a plurality of layers.

In some embodiments, the non-display area NDA of the display device DD may correspond to an area that is defined by printing a material including a desired color on one area of the window WM. As an example, the window WM may include a light blocking pattern for defining the non-display area NDA. The light blocking pattern that may be a colored organic film may be formed, for example, such as in a coating manner.

The window WM may be coupled to the display module DM through an adhesive film. As an example, the adhesive film may include an optically clear adhesive (OCA) film. However, the adhesive film is not limited thereto. For example, the adhesive film may include any suitable adhesive or sticking agent. For example, the adhesive film may include an optically clear resin (OCR) or a pressure sensitive adhesive (PSA) film.

An anti-reflection layer may be further disposed between the window WM and the display module DM. The anti-reflection layer decreases a reflectivity of external light incident from above the window WM. The anti-reflection layer according to an embodiment of the present disclosure may include a phase retarder and a polarizer. The phase retarder may be a film kind or a liquid crystal coating kind, and may include a λ/2 phase retarder and/or a λ/4 phase retarder. The polarizer may also be a film kind or a liquid crystal coating kind. The film kind may include a stretch-kind of synthetic resin film, and the liquid crystal coating kind may include liquid crystals arranged in a desired direction (e.g., a given or predetermined direction). The phase retarder and the polarizer may be implemented together with one polarization film.

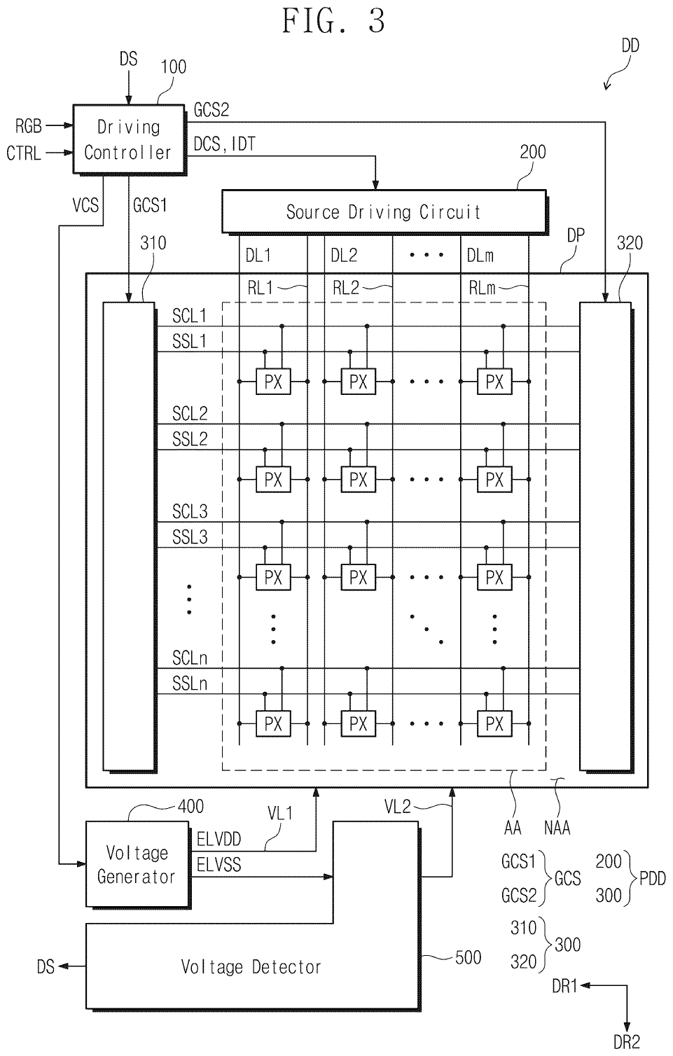

As an example, the anti-reflection layer may also include color filters. The arrangement of the color filters may be determined in consideration of the colors of light generated from a plurality of pixels PX (e.g., see FIG. 3) included in the display panel DP. In this case, the anti-reflection layer may further include a light blocking pattern disposed between the color filters.

The display module DM may display the image IM depending on an electrical signal, and may transmit/receive information about an external input. The display module DM may be defined by an active area AA and an inactive area NAA. The active area AA may be defined as an area (e.g., an area where the image IM is displayed) through which the image IM is output from the display panel DP. Also, the active area AA may be defined as an area in which the input sensing layer ISP senses the external input applied from the outside. According to an embodiment, the active area AA of the display module DM may correspond to (e.g., may overlap with) at least a part of the display area DA.

The inactive area NAA is adjacent to the active area AA. The inactive area NAA may be an area in which the image IM is not substantially displayed. For example, the inactive area NAA may surround (e.g., around a periphery of) the active area AA. However, the present disclosure is not limited thereto. The inactive area NAA may be defined in various suitable shapes, and is not particularly limited. According to an embodiment, the inactive area NAA of the display module DM may correspond to (e.g., may overlap with) at least a part of the non-display area NDA.

The display device DD may further include a plurality of flexible films FF connected to the display panel DP. A driver chip DIC may be mounted on each of the flexible films FF. As an example, a source driving circuit 200 (e.g., see FIG. 3) may include a plurality of driver chips DIC, and the plurality of driver chips DIC may be mounted on the plurality of flexible films FF, respectively.

The display device DD may further include at least one circuit board PCB coupled to the plurality of flexible films FF. As an example, two circuit boards PCB may be provided in the display device DD, but the number of circuit boards PCB is not limited thereto. Two adjacent circuit boards from among the circuit boards PCB may be electrically connected to each other by a connection film CF. Also, at least one of the circuit boards PCB may be electrically connected to a main board. A driving controller 100 (e.g., see FIG. 3), a voltage generator 400, and a voltage detector may be disposed on at least one of the circuit boards PCB.

FIG. 2 illustrates a structure in which the driver chips DIC are respectively mounted on the flexible films FF, but the present disclosure is not limited thereto. For example, the driver chips DIC may be directly mounted on the display panel DP. In this case, a portion of the display panel DP on which the driver chip DIC is mounted may be bent, such that the driver chip DIC is disposed on a rear surface of the display module DM.

The input sensing layer ISP may be electrically connected to the circuit board PCB through the flexible films FF. However, the present disclosure is not limited thereto. In other words, in some embodiments, the display module DM may additionally include a separate flexible film for electrically connecting the input sensing layer ISP and the circuit board PCB.

The display device DD further includes a housing EDC for accommodating the display module DM. The housing EDC may be coupled with the window WM to define an exterior appearance of the display device DD. The housing EDC may absorb external shocks, and may prevent or substantially prevent a foreign material/moisture or the like from being infiltrated into the display module DM, such that the components accommodated in the housing EDC are protected. As an example, the housing EDC may be provided in the form of a combination of a plurality of accommodating members.

The display device DD according to an embodiment may further include an electronic module (e.g., an electronic element or sensor) including various functional modules (e.g., functional elements or sensors) for operating the display module DM, a power supply module (e.g., a power supply or a battery) for supplying a power used for the overall operations of the display device DD, a bracket coupled with the display module DM and/or the housing EDC to partition an inner space of the display device DD, and the like.

FIG. 3 is a block diagram of a display device, according to an embodiment of the present disclosure.

Referring to FIG. 3, the display device DD includes a driving controller 100, a panel driver PDD, a voltage generator (e.g., a voltage generation circuit) 400, a voltage detector (e.g., a voltage detection circuit) 500, and a display panel DP. As an example, the panel driver PDD may include a source driving circuit 200 and a scan driving circuit 300. The source driving circuit 200 may include a data driver and a sensing driver.

The display panel DP includes driving scan lines SCL1 to SCLn, sensing scan lines SSL1 to SSLn, data lines DL1 to DLm, a plurality of sensing lines RL1 to RLm, and pixels PX, where n and m are integers greater than 1. The display panel DP may be divided into the active area AA and the inactive area NAA. The pixels PX may be positioned in the active area AA. The scan driving circuit 300 may be positioned in the inactive area NAA.

The driving scan lines SCL1 to SCLn and the sensing scan lines SSL1 to SSLn extend in parallel or substantially in parallel with the first direction DR1, and are arranged to be spaced from each other in the second direction DR2. The second direction DR2 may be a direction intersecting or crossing the first direction DR1. The data lines DL1 to DLm extend from the source driving circuit 200 in parallel or substantially in parallel with the second direction DR2, and are arranged spaced from each other in the first direction DR1. The sensing lines RL1 to RLm may extend in the second direction DR2, and may be arranged along the first direction DR1.

The plurality of pixels PX may be electrically connected to the driving scan lines SCL1 to SCLn, the sensing scan lines SSL1 to SSLn, the data lines DL1 to DLm, and the sensing lines RL1 to RLm. Each of the plurality of pixels PX may be electrically connected with two scan lines. However, the number of scan lines connected to each of the pixels PX is not limited thereto. For example, each pixel PX may be electrically connected to one scan line or three scan lines.

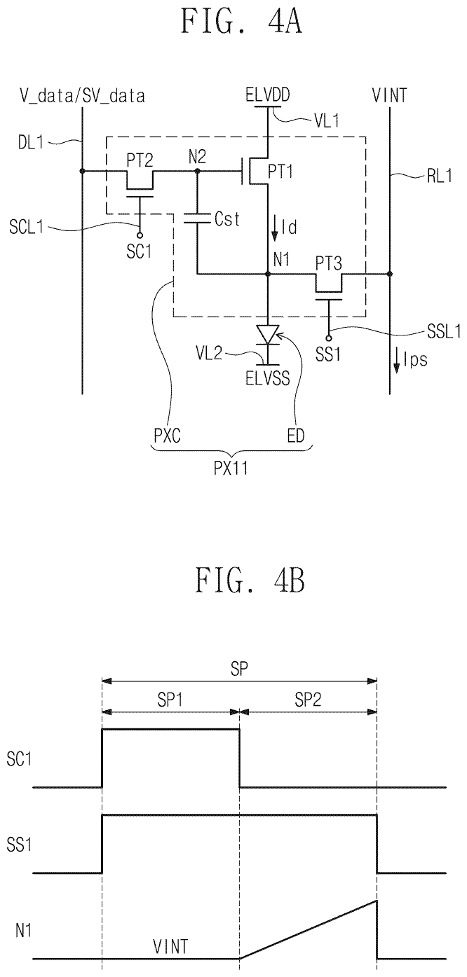

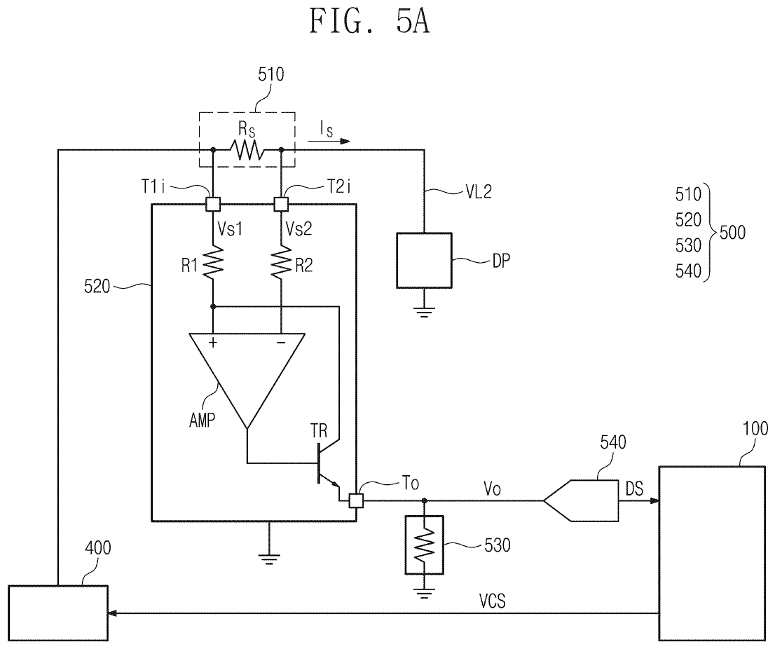

Each of the plurality of pixels PX includes a light emitting element ED (e.g., see FIG. 4A), and a pixel circuit PXC for controlling the emission of the light emitting element ED. The pixel circuit PXC may include a plurality of transistors and a capacitor.

The driving controller 100 receives an input image signal RGB and a control signal CTRL from a main processor (e.g., a microcontroller or a graphics controller). The driving controller 100 may generate image data IDT by converting the input image signal RGB.

The driving controller 100 generates a scan control signal GCS and a source control signal DCS based on a control signal CTRL. The source driving circuit 200 receives the source control signal DCS and the image data IDT from the driving controller 100, and converts the image data IDT into data signals in response to the source control signal DCS. The source driving circuit 200 outputs data signals to the plurality of data lines DL1 to DLm. The data signals may be analog voltages corresponding to grayscale values of the image data IDT.

The source driving circuit 200 is connected to the plurality of sensing lines RL1 to RLm. The source driving circuit 200 may further receive a sensing control signal from the driving controller 100, and may sense characteristics of the elements included in each of the pixels PX of the display panel DP in response to a sensing control signal.

As an example, the source driving circuit 200 may be formed with at least one chip (e.g., integrated circuit). The source driving circuit 200 may be disposed in the driver chips DIC shown in FIG. 2.

The scan driving circuit 300 receives the scan control signal GCS from the driving controller 100. The scan driving circuit 300 may output scan signals in response to the scan control signal GCS. The scan driving circuit 300 may be built into the display panel DP. When the scan driving circuit 300 is embedded in the display panel DP, the scan driving circuit 300 may include transistors formed through the same process as those of the pixel circuit PXC.

The scan driving circuit 300 may generate a plurality of driving scan signals and a plurality of sensing scan signals in response to the scan control signal GCS. The plurality of driving scan signals are applied to the driving scan lines SCL1 to SCLn. The plurality of sensing scan signals are applied to the sensing scan lines SSL1 to SSLn.

As an example, the scan driving circuit 300 includes a first scan driving circuit 310 and a second scan driving circuit 320. The first scan driving circuit 310 is placed on the left side of the active area AA. The second scan driving circuit 320 is placed on the right side of the active area AA. The first scan driving circuit 310 receives a first scan control signal GCS1 from the driver controller 100, and the second scan driving circuit 320 receives a second scan control signal GCS2 from the driver controller 100. The first scan driving circuit 310 may generate a plurality of driving scan signals and a plurality of sensing scan signals in response to the first scan control signal GCS1. The second scan driving circuit 320 may generate a plurality of driving scan signals and a plurality of sensing scan signals in response to the second scan control signal GCS2.

FIG. 3 shows a structure in which the first and second scan driving circuits 310 and 320 are positioned on the left and right sides, respectively, of the active area AA, but the present disclosure is not limited thereto. For example, the scan driving circuit 300 may include only one of the first or second scan driving circuits 310 or 320.

Each of the plurality of pixels PX may receive the first driving voltage ELVDD and the second driving voltage ELVSS.

The voltage generator 400 generates the voltages used to operate the display panel DP. In an embodiment of the present disclosure, the voltage generator 400 generates the first driving voltage ELVDD and the second driving voltage ELVSS, which are used for the operation of the display panel DP. The first driving voltage ELVDD and the second driving voltage ELVSS may be provided to the display panel DP through a first driving voltage line VL1 and a second driving voltage line VL2, respectively. As an example, the second driving voltage line VL2 may be connected to a cathode of a light emitting element ED as illustrated in FIG. 4A.

In addition to the first driving voltage ELVDD and the second driving voltage ELVSS, the voltage generator 400 may further generate various suitable voltages (e.g., a gamma reference voltage, a data driving voltage, a gate-on voltage, and a gate-off voltage) used for operations of the source driving circuit 200 and the scan driving circuit 300.

The voltage detector 500 may be connected to one of the first or second driving voltage lines VL1 or VL2, and may sense a sensing voltage corresponding to a current flowing through the one of the first or second driving voltage lines VL1 or VL2 in real time. The voltage detector 500 outputs a sensing signal DS based on the sensing voltage. As an example, FIG. 3 illustrates a structure in which the voltage detector 500 is connected to the second driving voltage line VL2, but the present disclosure is not limited thereto. For example, the voltage detector 500 may be connected to the first driving voltage line VL1.

The driving controller 100 receives the sensing signal DS from the voltage detector 500, and generates the voltage control signal VCS based on the sensing signal DS. The voltage generator 400 may determine the voltage level of one of the first or second driving voltages ELVDD or ELVSS based on the voltage control signal VCS.

FIG. 4A is an equivalent circuit diagram illustrating a pixel, according to an embodiment of the present disclosure. FIG. 4B is a waveform diagram illustrating an operation of the pixel shown in FIG. 4A in a sensing period.

FIG. 4A shows the equivalent circuit diagram of a first pixel PX11 from among the plurality of pixels PX shown in FIG. 3. Because each of the plurality of pixels PX may have the same or substantially the same circuit structure as that of the first pixel PX11, the circuit structure of the first pixel PX11 may be described in more detail hereinafter, and redundant description of the other remaining pixels from among the plurality of pixel PX may not be repeated.

Referring to FIG. 4A, the first pixel PX11 is connected to a first data line DL1, a first driving scan line SCL1, a first sensing scan line SSL1, and a first sensing line RL1.

The first pixel PX11 includes a light emitting element ED and a pixel circuit PXC. The light emitting element ED may be a light emitting diode. As an example, the light emitting element ED may be an organic light emitting diode including an organic light emitting layer. The light emitting element ED may be one of a red light emitting diode for emitting red light, a green light emitting diode that emits green light, or a blue light emitting diode that emits blue light.

The pixel circuit PXC includes first to third transistors PT1, PT2, and PT3, and a capacitor Cst. At least one of the first to third transistors PT1, PT2, or PT3 may be an oxide transistor having an oxide semiconductor layer. Each of the first to third transistors PT1, PT2, and PT3 may be an N-type transistor. However, the present disclosure is not limited thereto. For example, each of the first to third transistors PT1, PT2, and PT3 may be a P-type transistor. As another example, some of the first to third transistors PT1, PT2, and PT3 may be N-type transistors, and the other(s) of the first to third transistors PT1, PT2, and PT3 may be P-type transistors. In some embodiments, at least one of the first to third transistors PT1, PT2, or PT3 may be a transistor having a low-temperature polycrystalline silicon (LTPS) semiconductor layer.

A configuration of the pixel circuit PXC according to an embodiment of the present disclosure is not limited to that illustrated in FIG. 4A. The pixel circuit PXC illustrated in FIG. 4A is provided as an example. For example, the configuration of the pixel circuit PXC may be variously modified and implemented as needed or desired. For example, in the pixel circuit PXC, the third transistor PT3 may be omitted as needed or desired.

The first transistor PT1 (e.g., referred to as a “driving transistor”) is connected between the first driving voltage line VL1 for receiving the first driving voltage ELVDD and the light emitting element ED. The first transistor PT1 includes a first electrode connected to the first driving voltage line VL1, a second electrode electrically connected to an anode of the light emitting element ED, and a third electrode connected to one end of the capacitor Cst. A contact point where the anode of the light emitting element ED is connected to the second electrode of the first transistor PT1 may be referred to as a “first node N1”. As used herein, the phrase “a transistor is connected to a signal line” means that one of a first electrode, a second electrode, or a third electrode of the transistor is integrated with a signal line, or is connected to the signal line through a connection electrode. Also, the phrase “a transistor is electrically connected to another transistor” means that one of a first electrode, a second electrode, or a third electrode of the transistor is integrated with one of a first electrode, a second electrode, or a third electrode of the other transistor, or is connected to one of the first electrode, the second electrode, or the third electrode of the other transistor through a connection electrode”.

The first transistor PT1 may receive a data voltage V_data or a sensing data voltage SV_data, which is delivered through the first data line DL1 depending on a switching operation of the second transistor PT2, and may then supply a driving current to the light emitting element ED.

The second transistor PT2 (e.g., referred to as a “switching transistor”) is connected between the first data line DL1 and the third electrode of the first transistor PT1. The second transistor PT2 includes a first electrode connected to the first data line DL1, a second electrode connected to the third electrode of the first transistor PT1, and a third electrode connected to the first driving scan line SCL1. A contact point to which the second electrode of the second transistor PT2 is connected to the third electrode of the first transistor PT1 may be referred to as a “second node N2”. The second transistor PT2 is turned on in response to a first driving scan signal SC1 received through the first driving scan line SCL1, and may deliver the data voltage V_data or the sensing data voltage SV_data, which is delivered from the first data line DL1, to the third electrode of the first transistor PT1.

The third transistor PT3 is connected between the second electrode of the first transistor PT1 and the first sensing line RL1. The third transistor PT3 includes a first electrode connected to the first node N1, a second electrode connected to the first sensing line RL1, and a third electrode connected to the first sensing scan line SSL1. The third transistor PT3 may be turned on in response to the first sensing scan signal SS1 received through the first sensing scan line SSL1, so as to electrically connect the first sensing line RL1 and the first node N1 to each other.

One end of the capacitor Cst is connected to the second node N2, and another end (e.g., an opposite end) of the capacitor Cst is connected to the first node N1. A cathode of the light emitting element ED may be connected with the second driving voltage line VL2 that transfers the second driving voltage ELVSS. A voltage level of the second driving voltage ELVSS may be lower than a voltage level of the first driving voltage ELVDD.

The light emitting element ED may include the anode connected to the second electrode (e.g., the first node N1) of the first transistor PT1, and a cathode for receiving the second driving voltage ELVSS. The light emitting element ED may generate light corresponding to the amount of current supplied from the first transistor PT1.

As an example, the display device DD (e.g., see FIG. 3) displays an image in units of a frame. One frame may include a display period, in which an image is displayed, and a blank period, in which no image is displayed. During the display period, the data voltage V_data is applied to the first data line DL1, and an initialization voltage VINT is applied to the first sensing line RL1. The initialization voltage VINT may be a voltage for initializing the first node N1. When the third transistor PT3 is turned on depending on the first sensing scan signal SS1 during the display period, the first node N1 may be initialized to the initialization voltage VINT. The display period may be referred to as a “non-sensing period”.

The blank period may include a sensing period SP. The sensing period SP may include a write period SP1, in which the first driving scan signal SC1 and the first sensing scan signal SS1 are concurrently (e.g., simultaneously or substantially simultaneously) activated with each other, and a readout period SP2, in which only the first sensing scan signal SS1 is activated. During the write period SP1, the sensing data voltage SV_data is applied to the first data line DL1, and the initialization voltage VINT is applied to the first sensing line RL1. During the readout period SP2, the initialization voltage VINT is not applied to the first sensing line RL1.

During the write period SP1, the second transistor PT2 may be turned on in response to the first driving scan signal SC1, and the third transistor PT3 may be turned on in response to the first sensing scan signal SS1.

The sensing data voltage SV_data may be applied to the second node N2 (e.g., the third electrode of the first transistor PT1) through the first data line DL1 and the turned-on second transistor PT2. The sensing data voltage SV_data may be a voltage applied to the data lines DL1 to DLm during the sensing period SP, and may be a voltage suitable for (e.g., set for) a current sensing. The initialization voltage VINT may be applied to the first node N1 (e.g., the second electrode of the first transistor PT1 or the anode of the light emitting element ED) through the first sensing line RL1 and the turned-on third transistor PT3.

A voltage between the first node N1 and the second node N2 may be a difference between the sensing data voltage SV_data and the initialization voltage VINT. Electric charges corresponding to the difference between the sensing data voltage SV_data and the initialization voltage VINT may be charged in the capacitor Cst. A voltage between the first node N1 and the second node N2 may be defined as a gate-source voltage of the first transistor PT1.

After the write period SP1 ends, the first driving scan signal SC1 may be deactivated, and the second transistor PT2 may be turned off. Even though the second transistor PT2 is turned off, the voltage between the first node N1 and the second node N2 may be maintained or substantially maintained by the capacitor Cst during the readout period SP2.

Because the voltage between the first node N1 and the second node N2 may be greater than a threshold voltage of the first transistor PT1, a current (hereinafter referred to as a “drain current Id”) may flow through the first transistor PT1 during the readout period SP2. During the readout period SP2, a potential of the first node N1 may be boosted by the drain current Id, while the voltage between the first node N1 and the second node N2 is maintained. During the readout period SP2, the drain current Id may be output to the first sensing line RL1 through the turned-on third transistor PT3. A current output through the first sensing line RL1 may be referred to as a “pixel sensing current Ips”.

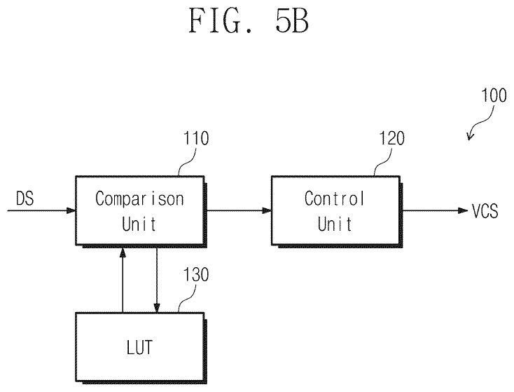

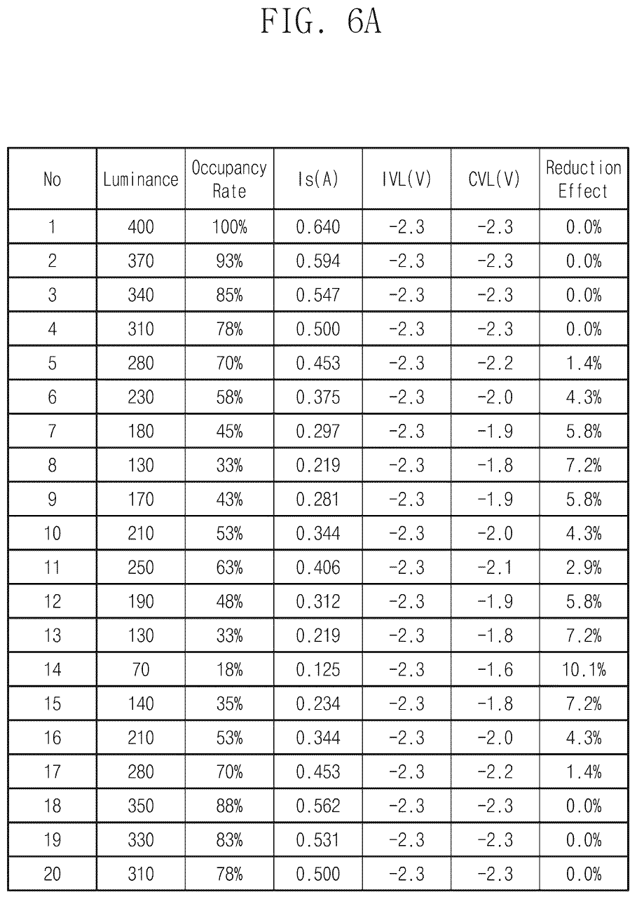

FIG. 5A is a block diagram showing a voltage detector, according to an embodiment of the present disclosure. FIG. 5B is a block diagram of a driving controller, according to an embodiment of the present disclosure.

Referring to FIG. 5A, the voltage detector 500 includes a detection unit (e.g., a detection circuit) 510, an amplification unit (e.g., an amplification circuit) 520, a gain control unit (e.g., a gain control circuit) 530, and a conversion unit (e.g., a conversion circuit) 540.

The detection unit 510 includes a sensing resistor Rs connected between the voltage generator 400 and the second driving voltage line VL2. The sensing resistor Rs senses a voltage (may be referred to as a “sensing voltage” or “cathode voltage”) corresponding to a current Is (may be referred to as a “sensing current” or “cathode current”) flowing into the second driving voltage line VL2. As an example, when the voltage detector 500 senses a voltage corresponding to the current flowing into the second driving voltage line VL2, the sensing resistor Rs may be connected between the voltage generator 400 and the second driving voltage line VL2. However, the present disclosure is not limited thereto. For example, when the voltage detector 500 senses a voltage corresponding to a current flowing into the first driving voltage line VL1, the sensing resistor Rs may be connected between the voltage generator 400 and the first driving voltage line VL1.

The amplification unit 520 includes a first input terminal T1i connected to a first end of the sensing resistor Rs and for receiving a first sensing voltage Vs1, a second input terminal T2i connected to a second end of the sensing resistor Rs and for receiving a second sensing voltage Vs2, and an output terminal To for outputting an output voltage Vo. The sensing voltage may refer to either the first sensing voltage Vs1 or the second sensing voltage Vs2. The amplification unit 520 may include an operational amplifier AMP and a transistor TR. A non-inverting terminal (e.g., a first terminal) of the operational amplifier AMP is connected to the first input terminal T1i, and an inverting terminal (e.g., a second terminal) of the operational amplifier AMP is connected to the second input terminal T2i. As an example, the amplification unit 520 may further include a first resistor R1 connected between the non-inverting terminal of the operational amplifier AMP and the first input terminal Tli, and a second resistor R2 connected between the inverting terminal of the operational amplifier AMP and the second input terminal T2i. The first and second resistors R1 and R2 may set a voltage amplification ratio of the operational amplifier AMP. The operational amplifier AMP may amplify a difference between first and second sensing voltages Vs1 and Vs2, and may output the amplified voltage.

The transistor TR includes an input electrode connected to the non-inverting terminal of the operational amplifier AMP, a control electrode connected to the output terminal of the operational amplifier AMP, and an output electrode connected to the output terminal To of the amplification unit 520. The transistor TR may operate in response to the amplified voltage output through the output terminal of the operational amplifier AMP, and may output the first sensing voltage Vs1 to the output terminal To of the amplification unit 520. When the amplification voltage is great (e.g., when the difference between the first and second sensing voltages Vs1 and Vs2 is great), the driving current of the transistor TR may increase, and thus, the amplification unit 520 may output a relatively high output voltage Vo. However, when the amplification voltage is small (e.g., when the difference between the first and second sensing voltages Vs1 and Vs2 is small), the driving current of the transistor TR may decrease, and thus, the amplification unit 520 may output the relatively low output voltage Vo.

The gain control unit 530 may adjust an amplification ratio (e.g., a gain) of the amplification unit 520. As an example, the gain control unit 530 may include a gain adjustment resistor connected between the output terminal To of the amplification unit 520 and a ground terminal to which a ground voltage is applied.

The conversion unit 540 may receive the output voltage Vo, and may convert the output voltage Vo into the sensing signal DS. As an example, the output voltage Vo may be an analog signal, and the sensing signal DS may be a digital signal. In other words, the conversion unit 540 may be an analog-to-digital converter that converts an analog signal into a digital signal.

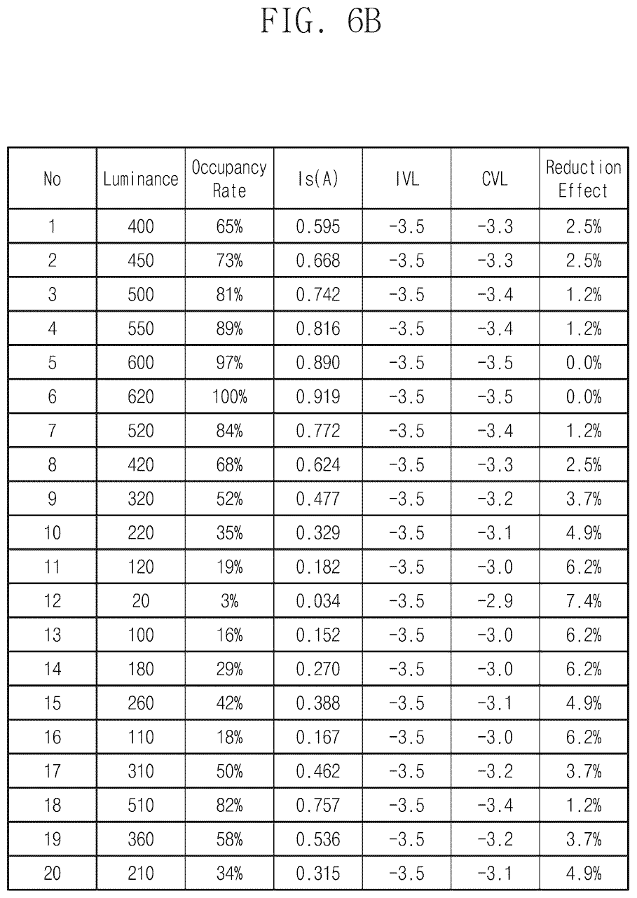

Referring to FIGS. 5A and 5B, the driving controller 100 includes a comparison unit (e.g., a comparator) 110, a look-up Table (LUT) 130, and a control unit (e.g., a controller) 120. The LUT 130 stores reference driving voltages respectively corresponding to a plurality of reference signals (e.g., a plurality of predetermined reference signals). The comparison unit 110 receives the sensing signal DS from the voltage detector 500 e.g., from the conversion unit 540), and selects a reference driving voltage corresponding to the sensing signal DS from the LUT 130. When the voltage detector 500 is connected to the second driving voltage line VL2, the reference driving voltages may have a voltage level higher than or equal to an initial voltage level IVL (e.g., see FIGS. 6A and 6B) of the second driving voltage ELVSS. For example, when the initial voltage level IVL of the second driving voltage ELVSS is about −3.5 V, each of the reference driving voltages may have a voltage level between about −3.5 V and about 0 V. When the voltage detector 500 is connected to the first driving voltage line VL1, each of the reference driving voltages may have a voltage level lower than or equal to the initial voltage level IVL of the first driving voltage ELVDD.

The comparison unit 110 provides the reference driving voltage corresponding to the sensing signal DS to the control unit 120. The control unit 120 may adjust the voltage control signal VCS, such that the second driving voltage ELVSS output from the voltage generator 400 has a voltage level corresponding to the reference driving voltage. The voltage control signal VCS may be provided by the voltage generator 400. The voltage generator 400 may adjust the voltage level of the second driving voltage ELVSS based on the voltage control signal VCS. As an example, the voltage control signal VCS may be a square wave signal. The control unit 120 may adjust a duty ratio of the voltage control signal VCS depending on the reference driving voltage. For example, when the reference driving voltage has the same or substantially the same voltage level as the initial voltage level IVL of the second driving voltage ELVSS, the voltage control signal VCS may have a maximum duty ratio (e.g., a predetermined maximum duty ratio). When the reference driving voltage has a level higher than the initial voltage level IVL of the second driving voltage ELVSS, the voltage control signal VCS may have a duty ratio less than the maximum duty ratio. When the voltage control signal VCS having a duty ratio less than the maximum duty ratio is received, the voltage generator 400 may adjust the voltage level of the second driving voltage ELVSS to be higher than the initial voltage level IVL. The adjusted voltage level of the second driving voltage ELVSS may be referred to as an “adjusted voltage level” CVL (e.g., see FIGS. 6A and 6B).

FIGS. 6A and 6B are tables showing a power consumption reduction depending on a luminance and an occupancy rate by a voltage detector, according to some embodiments of the present disclosure.

Referring to FIGS. 5A to 6B, the magnitude of the sensing current Is may be determined by the luminance of the image displayed on the display panel DP, and an occupancy rate of an area where a high luminance image is displayed. In other words, when the peak luminance of the image displayed on the display panel DP is high, and the occupancy rate of the area with the peak luminance is high, the sensing current Is may be increased. However, when the peak luminance is low, and the occupancy rate of the area with peak luminance is low, the sensing current Is may be decreased.

FIG. 6A shows the sensing current Is, which is measured depending on the peak luminance and the occupancy rate, and the adjusted voltage level CVL of the second driving voltage ELVSS, which is adjusted accordingly, in the display panel DP having a peak luminance of up to about 400 nits.

Referring to FIG. 6A, when the peak luminance of an image displayed on the display panel DP is about 400 nits, and the occupancy rate of an area having the peak luminance is about 100%, the second driving voltage may have a level of about −2.3 V (e.g., the initial voltage level IVL). However, when the peak luminance of the image is 210 nits, and the occupancy rate of the area with the peak luminance is about 53%, the sensing current decreases, and thus, the second driving voltage ELVSS may have the adjusted voltage level CVL of about −2.0 V. In this case, the effect of reducing the total power consumption of the display device DD (e.g., see FIG. 3) by about 4.3% may be achieved. When the peak luminance of the image is 70 nits, and the occupancy rate of the area with the peak luminance is about 18%, the sensing current may be further decreased, and thus, the second driving voltage ELVSS may have the adjusted voltage level CVL of about −1.6 V. In this case, the effect of reducing the overall power consumption of the display device DD by about 10.1% may be achieved. In other words, as the peak luminance decreases and the occupancy rate decreases, a reduction effect on a power consumption may be increased.

FIG. 6B shows the sensing current Is, which is measured depending on the peak luminance and the occupancy rate, and the adjusted voltage level CVL of the second driving voltage ELVSS, which is adjusted accordingly, in the display panel DP having a peak luminance of up to about 620 nits.

Referring to FIG. 6B, when the peak luminance of an image displayed on the display panel DP is about 620 nits, and the occupancy rate of an area having the peak luminance is about 100%, the second driving voltage may have a level of about −3.5 V (e.g., the initial voltage level IVL). However, when the peak luminance of the image is about 320 nits, and the occupancy rate of the area with the peak luminance is about 52%, the sensing current decreases, and thus, the second driving voltage ELVSS may have the adjusted voltage level CVL of about −3.2 V. In this case, the effect of reducing the total power consumption of the display device DD (e.g., see FIG. 3) by about 3.7% may be achieved. When the peak luminance of the image is about 100 nits, and the occupancy rate of the area with the peak luminance is about 16%, the sensing current may be further decreased, and thus, the second driving voltage ELVSS may have the adjusted voltage level CVL of about −3.0 V. In this case, the effect of reducing the overall power consumption of the display device DD by about 6.2% may be achieved. In other words, as the peak luminance decreases and the occupancy rate decreases, a reduction effect on a power consumption may be increased.

As the voltage level of the second driving voltage ELVSS generated from the voltage generator 400 decreases, and the voltage level of the first driving voltage ELVDD increases, the power consumption of the display device DD increases. As such, the second driving voltage ELVSS may be adjusted to have an optimal or improved voltage level depending on the sensing current Is through the voltage detector 500, thereby reducing the power consumption of the display device DD.

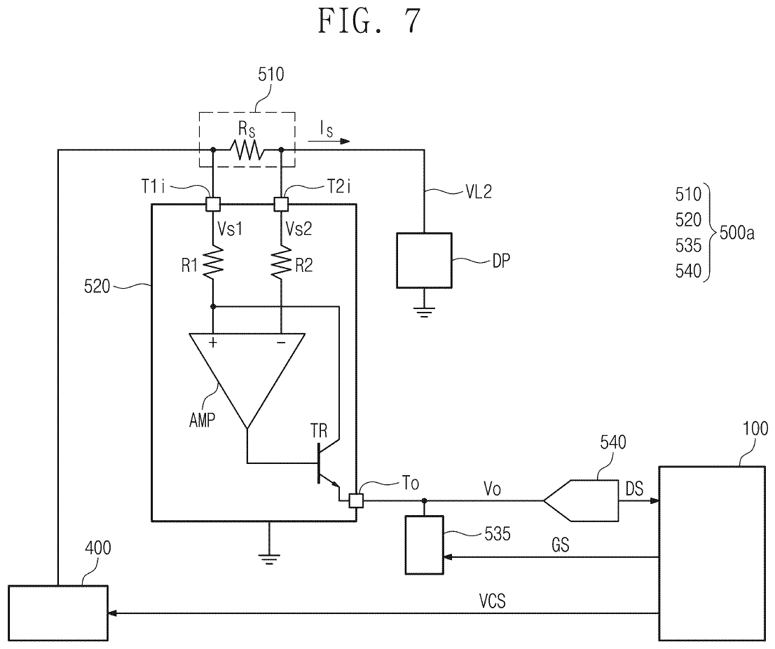

FIG. 7 is a block diagram showing a voltage detector, according to an embodiment of the present disclosure.

Referring to FIG. 7, a voltage detector 500a includes the detection unit 510, the amplification unit 520, a gain control unit (e.g., a gain control circuit) 535, and the conversion unit 540. The configuration of the detection unit 510, the amplification unit 520, and the conversion unit 540 illustrated in FIG. 7 may be the same or substantially the same as the configuration of the detection unit 510, the amplification unit 520, and the conversion unit 540 described above with reference to FIG. 5A, and thus, redundant description thereof may not be repeated hereinafter.

The gain control unit 535 may adjust an amplification ratio (e.g., a gain) of the amplification unit 520. As an example, the gain control unit 535 may include a digital variable resistor connected to the output terminal To of the amplification unit 520. The gain control unit 535 may receive a gain adjustment signal GS from the driving controller 100, and may vary the level of the digital variable resistor based on the gain adjustment signal GS.

The gain control unit 530 illustrated in FIG. 5A includes a gain adjustment resistor having a fixed level, and thus, the amplification ratio of the amplification unit 520 may be fixed to a value initially set by the gain adjustment resistor. However, when the gain control unit 535 includes a digital variable resistor as shown in FIG. 7, the gain control unit 535 may adjust the amplification ratio of the amplification unit 520 in consideration of a surrounding condition (e.g., a temperature, a deterioration of a light emitting element, or the like). Accordingly, the voltage detector 500a may more accurately sense a sensing voltage without being affected by the surrounding condition.

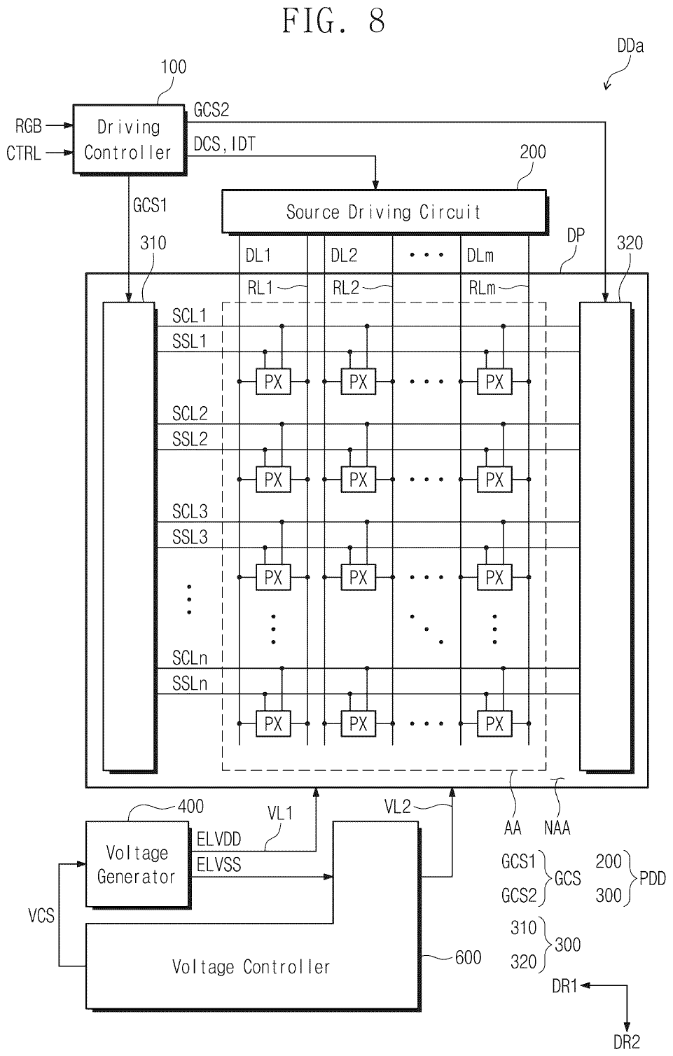

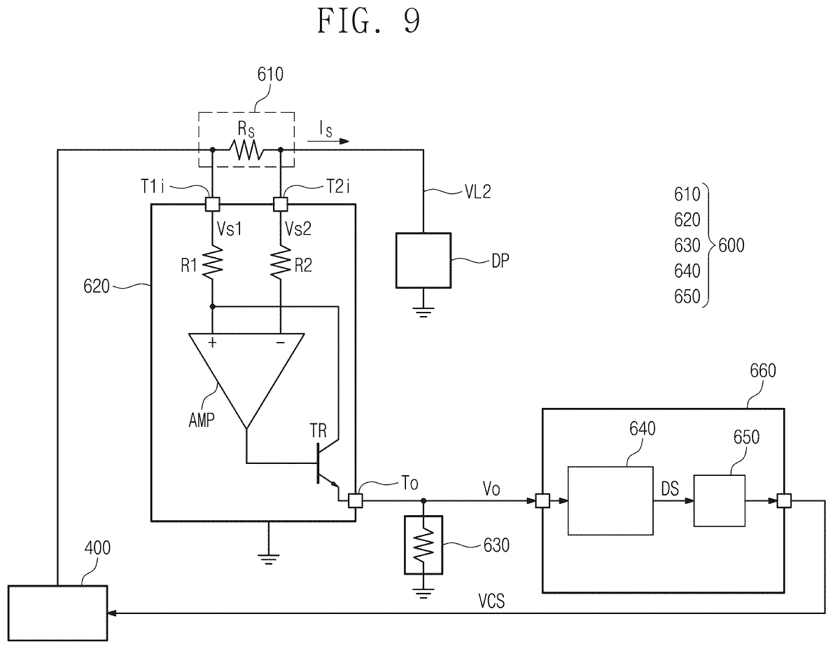

FIG. 8 is a block diagram of a display device, according to an embodiment of the present disclosure. FIG. 9 is a block diagram showing a voltage controller, according to an embodiment of the present disclosure. In FIG. 8, the same reference numerals are used to denote the same or substantially the same components as those described above with reference to FIG. 3, and thus, redundant description thereof may not be repeated hereinafter.

Referring to FIG. 8, the display device DDa includes the driving controller 100, the source driving circuit 200, the scan driving circuit 300, the voltage generator (e.g., the voltage generation circuit) 400, a voltage controller (e.g., a voltage control circuit) 600, and the display panel DP.

The voltage controller 600 may be connected to one of the first or second driving voltage lines VL1 or VL2, and may sense a sensing voltage corresponding to a current flowing through the one of the first or second driving voltage lines VL1 or VL2 in real time. The voltage controller 600 generates the sensing signal DS based on the sensing voltage, and outputs the voltage control signal VCS based on the sensing signal DS. The voltage generator 400 may determine the voltage level of one of the first or second driving voltages ELVDD or ELVSS based on the voltage control signal VCS.

As an example, FIG. 8 illustrates a structure in which the voltage controller 600 is connected to the second driving voltage line VL2, but the present disclosure is not limited thereto. For example, the voltage controller 600 may be connected to the first driving voltage line VL1.

Referring to FIG. 9, the voltage controller 600 includes a detection unit (e.g., a detection circuit) 610, an amplification unit (e.g., an amplification circuit) 620, a gain control unit (e.g., a gain control circuit) 630, a conversion unit (e.g., a conversion circuit) 640, and a control unit (e.g., a controller) 650. The configuration of the detection unit 610, the amplification unit 620, the gain control unit 630, and the conversion unit 640 illustrated in FIG. 9 may be the same or substantially the same as the configuration of the detection unit 510, the amplification unit 520, the gain control unit 530, and the conversion unit 540 described above with reference to FIG. 5A, and thus, redundant description thereof may not be repeated hereinafter.

The control unit 650 may receive the sensing signal DS from the conversion unit 640, and may select a reference driving voltage corresponding to the sensing signal DS from a look-up table in which reference driving voltages corresponding to a plurality of reference signals, respectively, are stored. The control unit 650 may adjust the voltage control signal VCS, such that the second driving voltage ELVSS output from the voltage generator 400 has a voltage level corresponding to the selected reference driving voltage. The voltage control signal VCS may be provided by the voltage generator 400. The voltage generator 400 may adjust the voltage level of the second driving voltage ELVSS based on the voltage control signal VCS. As an example, the voltage control signal VCS may be a square wave signal. The control unit 650 may adjust a duty ratio of the voltage control signal VCS depending on the reference driving voltage.

As an example, the conversion unit 640 and the control unit 650 may be embedded in one voltage control chip 660. However, the present disclosure is not limited thereto, and the conversion unit 640 and the control unit 650 may be implemented as separate chips from each other.

As such, the second driving voltage ELVSS may be adjusted to have an optimal or improved voltage level depending on the sensing current Is through the voltage controller 600, thereby reducing the power consumption of the display device DDa.

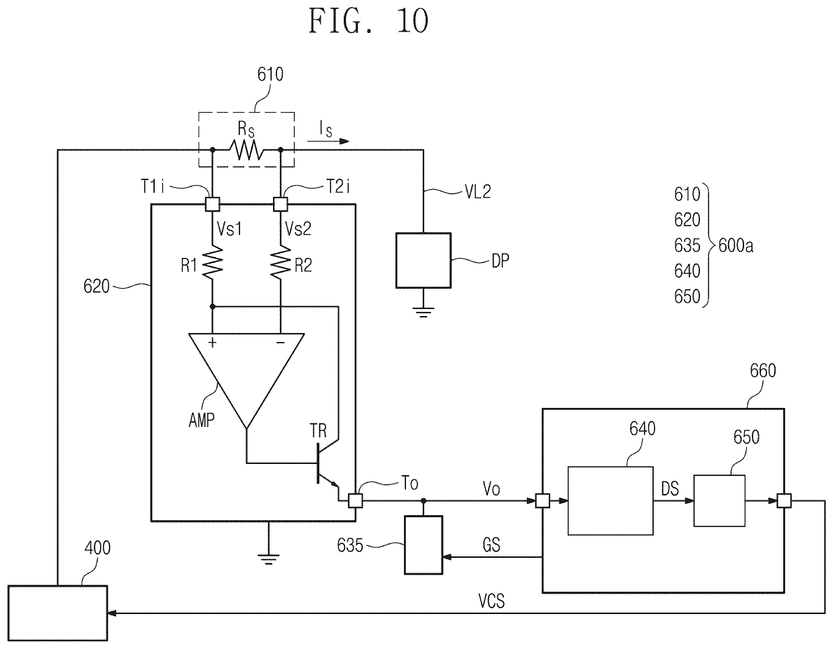

FIG. 10 is a block diagram showing a voltage controller, according to an embodiment of the present disclosure.

Referring to FIG. 10, a voltage controller 600a includes the detection unit 610, the amplification unit 620, a gain control unit (e.g., a gain control circuit) 635, the conversion unit 640, and the control unit 650. The configuration of the detection unit 610, the amplification unit 620, and the conversion unit 640 illustrated in FIG. 10 may be the same or substantially the same as the configuration of the detection unit 610, the amplification unit 620, and the conversion unit 640 described above with reference to FIG. 9, and thus, redundant description thereof may not be repeated hereinafter.

The gain control unit 635 may adjust an amplification ratio (e.g., a gain) of the amplification unit 620. As an example, the gain control unit 635 may include a digital variable resistor connected to the output terminal To of the amplification unit 620. The gain control unit 635 may receive the gain adjustment signal GS from the control unit 650 (e.g., the voltage control chip 660), and may vary the level of the digital variable resistor based on the gain adjustment signal GS.

The gain control unit 630 illustrated in FIG. 9 includes a gain adjustment resistor having a fixed level, and thus, the amplification ratio of the amplification unit 620 may be fixed to a value initially set by the gain adjustment resistor. However, when the gain control unit 635 includes a digital variable resistor as shown in FIG. 10, the gain control unit 535 may adjust the amplification ratio of the amplification unit 620 in consideration of a surrounding condition (e.g., a temperature, a deterioration of a light emitting element, or the like). Accordingly, the voltage controller 600a may more accurately sense a sensing voltage without being affected by the surrounding condition.

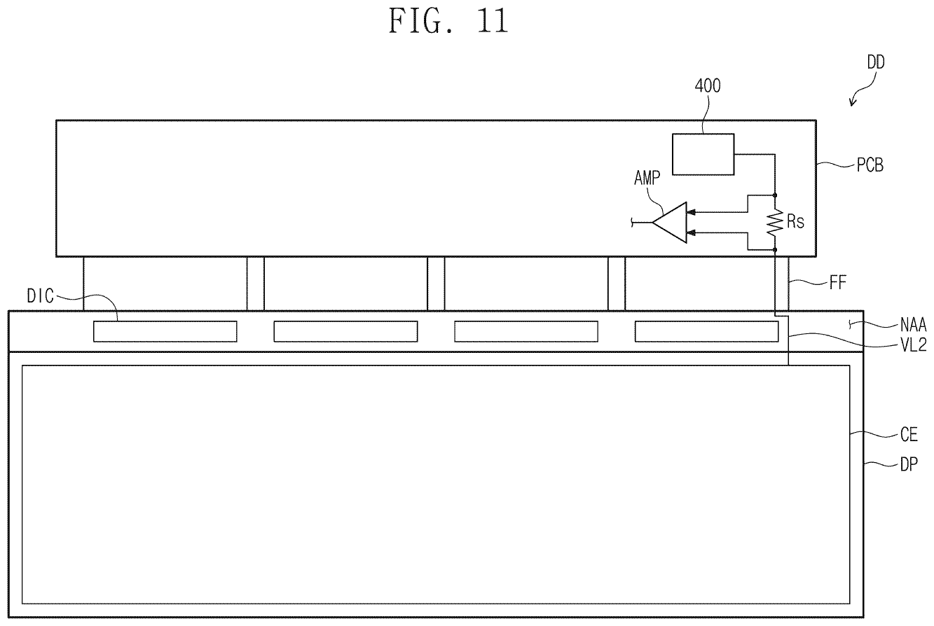

FIG. 11 is a plan view of a display device, according to an embodiment of the present disclosure.

Referring to FIG. 11, the display device DD includes the display panel DP, the plurality of flexible films FF, the plurality of driver chips DIC, and a circuit board PCB. As an example, the driver chips DIC may be mounted on the inactive area NAA of the display panel DP.

A common cathode electrode CE may be formed throughout the active area AA of the display panel DP (e.g., see FIG. 2). The common cathode electrode CE may form the cathode of the light emitting elements ED (e.g., see FIG. 4A) provided in each of the pixels PX (e.g., see FIG. 3). The common cathode electrode CE is electrically connected to the second driving voltage line VL2.

The display device DD further includes the voltage generator 400 and the voltage detector 500 or 500a. As an example, the voltage generator 400 and the voltage detector 500 or 500a may be placed on the circuit board PCB. Although only a partial configuration of the voltage detector 500 or 500a is shown in FIG. 11, the other remaining configurations may also be placed on the circuit board PCB. Moreover, the voltage controller 600 or 600a illustrated in FIGS. 9 and 10 may also be placed on the circuit board PCB.

In FIG. 11, only the structure in which the one voltage detector 500 or 500a is connected to the display panel DP is illustrated, but the present disclosure is not limited thereto. For example, when the display panel DP is divided into a plurality of voltage detection areas, a plurality of voltage detectors may be connected to the voltage detection areas, respectively. Accordingly, each voltage detector may sense the sensing voltage for a corresponding voltage detection area, and thus, the optimum or improved voltage level of the second driving voltage may be set for each voltage detection area.

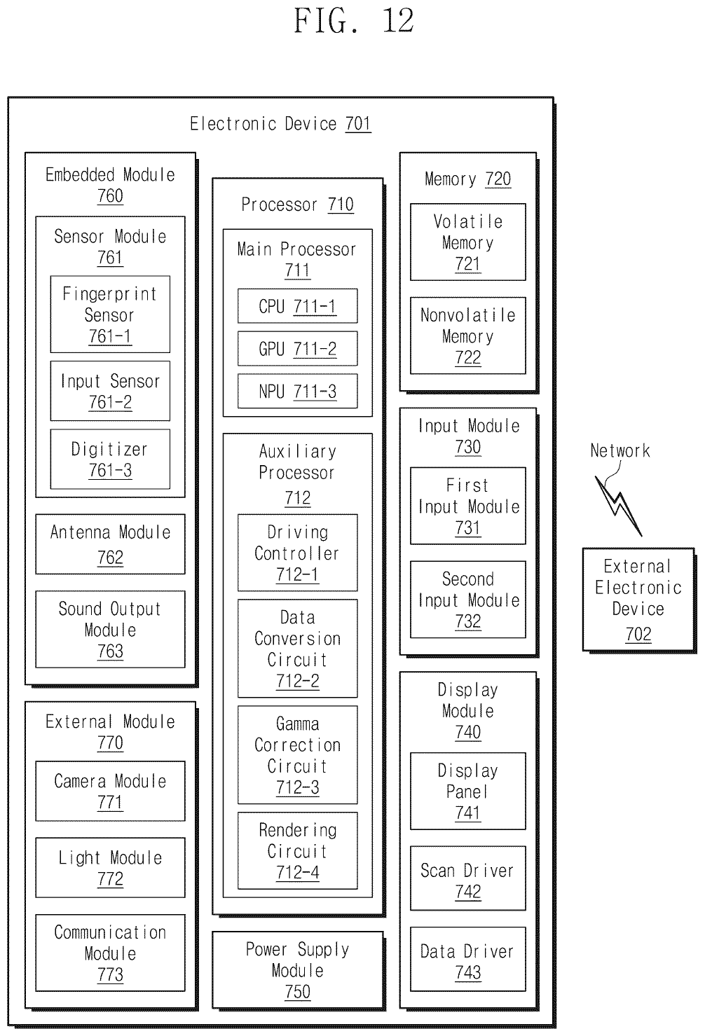

FIG. 12 is a block diagram of an electronic device, according to an embodiment of the present disclosure.

Referring to FIG. 12, an electronic device 701 outputs various pieces of information through a display module 740 within an operating system. When a processor 710 executes an application stored in a memory 720, the display module 740 provides application information to a user through a display panel 741.

The processor 710 obtains an external input through an input module 730 or a sensor module 761, and executes an application corresponding to the external input. For example, when the user selects a camera icon displayed on the display panel 741, the processor 710 obtains a user input through an input sensor 761-2, and activates a camera module 771. The processor 710 delivers image data corresponding to a captured image obtained through the camera module 771 to the display module 740. The display module 740 may display an image corresponding to the captured image through the display panel 741.

As another example, when personal information is authenticated on the display module 740, a fingerprint sensor 761-1 obtains entered fingerprint information as input data. The processor 710 compares input data obtained through the fingerprint sensor 761-1 with authentication data stored in the memory 720, and executes an application based on the comparison result. The display module 740 may display information, which is executed depending on a logic of the application, through the display panel 741.

As another example, when a music streaming icon displayed on the display module 740 is selected, the processor 710 obtains a user input through the input sensor 761-2, and activates the music streaming application stored in the memory 720. When a music play command is input by the music streaming application, the processor 710 provides sound information corresponding to the music play command to the user by activating a sound output module 763.

The operation of the electronic device 701 has been briefly described above. Hereinafter, a configuration of the electronic device 701 will be described in more detail. Some of the components of the electronic device 701, which are described in more detail below, may be integrated with each other and provided as one configuration, or the one configuration may be provided to be separated into two or more configurations.

Referring to FIG. 12, the electronic device 601 may communicate with an external electronic device 702 through a network (e.g., a short-range wireless communication network or a long-range wireless communication network). According to an embodiment, the electronic device 701 may include the processor 710, the memory 720, the input module 730, the display module 740, a power supply module 750, an embedded module 760, and an external module 770. According to an embodiment, in the electronic device 701, at least one of the above-described components may be omitted, or one or more other components may be added. According to an embodiment, some (e.g., the sensor module 761, an antenna module 762, or the sound output module 763) of the components described above may be integrated into another component (e.g., the display module 740).

The processor 710 may execute software to control at least another component (e.g., hardware or software component) of the electronic device 701 connected to the processor 710, and may process and calculate various suitable kinds of data. According to an embodiment, as at least part of data processing or calculation, the processor 710 may store instructions or data received from other components (e.g., the input module 730, the sensor module 761 or a communication module 773) into a volatile memory 721, may process instructions or data stored in the volatile memory 721. The result data may be stored in a nonvolatile memory 722.

The processor 710 may include a main processor 711 and an auxiliary processor 712. The main processor 711 may include one or more of a central processing unit (CPU) 711-1 or an application processor (AP). The main processor 711 may further include one or more of a graphic processing unit (GPU) 711-2, a communication processor (CP), and an image signal processor (ISP). The main processor 711 may further include a neural processing unit (NPU) 711-3. The NPU 711-3 may be a processor that is specialized in processing an artificial intelligence model. The artificial intelligence model may be generated through machine learning. The artificial intelligence model may include a plurality of artificial neural network layers. The artificial neural network may be one of a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more of the networks, but may not be limited to the above-described example. In addition to a hardware structure, additionally or alternatively, the artificial intelligence model may include a software structure. At least two of the processing units and the processors that are described above may be implemented as one integrated component (e.g., a single chip) or may be implemented as independent components (e.g., a plurality of chips).

The auxiliary processor 712 may include a driving controller 712-1. The driving controller 712-1 may include an interface converting circuit and a timing control circuit. The driving controller 712-1 receives an image signal from the main processor 711, converts the data format of the image signal so as to be suitable for the interface specifications with the display module 740, and outputs image data. The driving controller 712-1 may output various control signals required to drive the display module 740. The configuration of the driving controller 712-1 is substantially similar to the driving controller 100 shown in FIG. 3, and thus detailed descriptions are omitted to avoid redundancy.

The auxiliary processor 712 may further include a data converting circuit 712-2, a gamma correcting circuit 712-3, and a rendering circuit 712-4. The data converting circuit 712-2 may receive the image data from the driving controller 712-1 and may compensates for the image data such that an image is displayed at a desired luminance according to characteristics of the electronic device 701 or setting of the user or may convert the image data to reduce power consumption or compensate for afterimages. The gamma correcting circuit 712-3 may convert the image data, a gamma reference voltage, or the like such that the image displayed on the electronic device 701 has desired gamma characteristics. The rendering circuit 712-4 may receive the image data from the driving controller 712-1 and may render the image data in consideration of a pixel arrangement of the display panel 741 applied to the electronic device 701. At least one of the data converting circuit 712-2, the gamma correcting circuit 712-3, and the rendering circuit 712-4 may be integrated into another component (e.g., the main processor 711 or the driving controller 712-1). At least one of the data converting circuit 712-2, the gamma correcting circuit 712-3, and the rendering circuit 712-4 may be integrated into a data driver 743.

The memory 720 may store various pieces of data, which are used by at least one component (e.g., the processor 710 or the sensor module 761) of the electronic device 701 and input data or output data for commands related thereto. The memory 720 may include at least one or more of the volatile memory 721 and the nonvolatile memory 722.

The input module 730 may receive, from the outside (e.g., the user or an external electronic device 702) of the electronic device 701, commands or data to be used in a components (e.g., the processor 710, the sensor module 761, or the sound output module 763) of the electronic device 701.

The input module 730 may include a first input module 731, through which the commands or data are input from the user, and a second input module 732 through which the commands or data are input from the external electronic device 702. The first input module 731 may include a microphone, a mouse, a keyboard, a key (e.g., a button), or a pen (e.g., a passive pen or an active pen). The second input module 732 may support a designated protocol capable of being connected to the external electronic device 702 by wire or wirelessly. According to an embodiment, the second input module 732 may include a high definition multimedia interface (HDMI), a universal serial bus (USB) interface, a secure digital (SD) card interface, or an audio interface. The second input module 732 may include a connector that may be physically connected to the external electronic device 702, for example, an HDMI connector, a USB connector, an SD card connector, or an audio connector (e.g., a headphone connector).

The display module 740 provides visual information to the user. The display module 740 may include the display panel 741, a scan driver 742, and the data driver 743. The display module 740 may further include a window, a chassis, a bracket, or the like for protecting the display panel 741. The display module 740 may further include a light emitting driver, a voltage generator, and the like. The voltage generator may output various voltages (e.g., the first and second driving voltages ELVDD and ELVSS (e.g., see FIG. 3)) required to drive the display panel 741. The configuration of the display panel 741, the scan driver 742, the data driver 743, and the voltage generator is substantially similar to the configuration of the display panel DP, the first and second scan driving circuits 310 and 320, the source driving circuit 200, and the voltage generator 400 shown in FIG. 3, and thus detailed descriptions are omitted to avoid redundancy.

The power supply module 750 supplies power to the components of the electronic device 701. The power supply module 750 may include a battery that charges a power voltage. The battery may include a non-rechargeable primary cell, a rechargeable secondary cell, a fuel cell, or the like. The power supply module 750 may include a power management integrated circuit (PMIC). The PMIC supplies optimized power to the above-described modules and modules which will be described below. The power supply module 750 may include a wireless power transmission/reception member electrically connected to the battery. The wireless power transmission/reception member may include a plurality of coil-shaped antenna radiators.

The electronic device 701 may further include the embedded module 760 and the external module 770. The embedded module 760 may include the sensor module 761, the antenna module 762, and the sound output module 763. The external module 770 may include the camera module 771, a light module 772, and the communication module 773.

The sensor module 761 may detect an input from the user's body or an input from a pen among the first input module 731, and may generate an electrical signal or data value corresponding to the input. The sensor module 761 may include at least one of the fingerprint sensor 761-1, the input sensor 761-2, and a digitizer 761-3.

The fingerprint sensor 761-1 may generate a data value corresponding to a fingerprint of the user. The fingerprint sensor 761-1 may include one of an optical-type fingerprint sensor, or a capacitance-type fingerprint sensor.

The input sensor 761-2 may generate a data value corresponding to coordinate information of an input by a body of the user or an input by a pen. The input sensor 761-2 generates the change in capacitance due to the input as the data value. The input sensor 761-2 may sense an input by a passive pen or may transmit or receive data to or from an active pen.

The input sensor 761-2 may also measure a biometric signal such as blood pressure, moisture, or body fat. For example, when the user touches a part of the body to a sensor layer or sensing panel and does not move during a specific period, the input sensor 761-2 may detect the biometric signal and may output information desired by the user to the display module 740 based on a changes in electric fields caused by the part of the body.

The digitizer 761-3 may generate the data value corresponding to coordinate information of an input by the pen. The digitizer 761-3 generates an electromagnetic change amount due to the input as the data value. The digitizer 761-3 may sense input by the passive pen or transmit or receive data to or from the active pen.

At least one of the fingerprint sensor 761-1, the input sensor 761-2, and the digitizer 761-3 may be implemented as a sensor layer formed on the display panel 741 through a subsequent process. The fingerprint sensor 761-1, the input sensor 761-2, and the digitizer 761-3 may be placed on the upper side of the display panel 741, and one (e.g., the digitizer 761-3) of the fingerprint sensor 761-1, the input sensor 761-2, and the digitizer 761-3 may be placed on the lower side of the display panel 741.

At least two or more of the fingerprint sensor 761-1, the input sensor 761-2, and the digitizer 761-3 may be formed to be integrated into one sensing panel through the same process. When being integrated into one sensing panel, the sensing panel may be placed between the display panel 741 and a window placed on the upper side of the display panel 741. According to an embodiment, the sensing panel may be placed on a window, and the location of the sensing panel is not particularly limited thereto.

At least one of the fingerprint sensor 761-1, the input sensor 761-2, and the digitizer 761-3 may be built into the display panel 741. In other words, at least one of the fingerprint sensor 761-1, the input sensor 761-2, and the digitizer 761-3 may be simultaneously formed through a process of forming elements (e.g., a light emitting element, a transistor, or the like) included in the display panel 741.

Besides, the sensor module 761 may generate an electrical signal or a data value corresponding to the internal state or external state of the electronic device 701. For example, the sensor module 761 may further include a gesture sensor, a gyro sensor, a barometric pressure sensor, a magnetic sensor, an acceleration sensor, a grip sensor, a proximity sensor, a color sensor, an infrared (IR) sensor, a biometric sensor, a temperature sensor, a humidity sensor, or an illumination sensor.

The antenna module 762 may include one or more antennas to transmit or receive the signal or power to or from an external source. According to an embodiment, the communication module 773 may transmit or receive the signal to or from the external electronic device through the antenna suitable for a communication method. An antenna pattern of the antenna module 762 may be integrated into the input sensor 761-2 or one component (e.g., the display panel 741) of the display module 740.

The audio output module 763 may be a device for outputting an audio signal to the outside of the electronic device 701 and, for example, may include a speaker used for general purposes, such as multimedia playback or recording playback, and a receiver used only for receiving a call. According to an embodiment, the receiver may be implemented separately from the speaker or may be integrated with the speaker. A sound output pattern of the sound output module 763 may be integrated into the display module 640.

The camera module 771 may shoot a still image or a video image. According to an embodiment, the camera module 771 may include one or more lenses, an image sensor, or an image signal processor. The camera module 771 may further include an infrared camera capable of measuring the presence or absence of the user, a position of the user, a gaze of the user, or the like.

The light module 772 may provide light. The light module 772 may include a light emitting diode or a xenon lamp. The light module 772 may operate in conjunction with the camera module 771 or may operate independently from the camera module 771.

The communication module 773 may support establishing a wired or wireless communication channel between the electronic device 701 and the external electronic device 702 and performing communication through the established communication channel. The communication module 773 may include one or all of wireless communication modules such as a cellular communication module, a short-range wireless communication module, or a global navigation satellite system (GNSS) communication module, or wired communication modules such as a local area network (LAN) communication module or a power line communication module. The communication module 773 may communicate with the external electronic device 702 through a short-range communication network such as Bluetooth, WiFi direct, or infrared data association (IrDA) or a long-range communication network such as a cellular network, Internet, or a computer network (e.g., the LAN or a wide area network (WAN)). The above-mentioned various communication modules 773 may be implemented into one chip or may be respectively implemented into separate chips.

The input module 730, the sensor module 761, the camera module 771, and the like may be utilized to control an operation of the display panel 740 in conjunction with the processor 710.

The processor 710 outputs commands or data to the display module 740, the sound output module 763, the camera module 771, or the light module 772 based on input data received from the input module 730. For example, the processor 710 may generate image data in response to input data applied through a mouse, an active pen, or the like to output the generated image data to the display module 640 or may generate command data in response to the input data to output the generated command data to the camera module 771 or the light module 772. When no input data is received from the input module 730 during a specific period, the processor 710 may switch an operation mode of the electronic device 701 to a low-power mode or a sleep mode to reduce power consumed in the electronic device 701.

The processor 710 outputs commands or data to the display module 740, the sound output module 763, the camera module 771, or the light module 772 based on sensing data received from the sensor module 761. For example, the processor 710 may compare authentication data authorized by the fingerprint sensor 761-1 with the authentication data stored in the memory 720, and then may execute an application depending on the comparison result. The processor 710 may execute commands or may output corresponding image data to the display module 740 based on sensing data sensed by the input sensor 761-2 or the digitizer 761-3. When the sensor module 761 includes a temperature sensor, the processor 710 receives temperature data regarding the measured temperature from the sensor module 761 and may further perform luminance correction on image data based on the temperature data.

The processor 710 may receive measurement data regarding the presence or absence of the user, the user's location, and the user's gaze from the camera module 771. The processor 710 may further perform luminance correction on the image data based on the measurement data. For example, the processor 710 that determines the presence or absence of the user through an input from the camera module 771 may output image data, of which the luminance is corrected, to the display module 740 through the data converting circuit 712-2 or the gamma correcting circuit 712-3.

Some of the components may be connected to each other through communication methods between peripheral devices, for example, a bus, a general purpose input/output (GPIO), a serial peripheral interface (SPI), a mobile industry processor interface (MIPI), or an ultra-path interconnect (UPI) link and may exchange a signal (e.g., commands or data) between each other. The processor 710 may communicate with the display module 740 through a mutually promised interface, and for example, may use any one of the above-described communication methods, and the present disclosure is not limited to the above-described communication methods.

The electronic device 701 according to various embodiments described above may be implemented with various suitable kinds of devices. The electronic device 701 may include, for example, at least one of a portable communication device (e.g., a smart phone), a computer device, a portable multimedia device, a portable medical device, a camera, a wearable device, or a home appliance. However, the electronic device 701 may not be limited to the above-described devices.

Although some embodiments of the present disclosure have been described for illustrative purposes, those skilled in the art will appreciate that various modifications and substitutions are possible, without departing from the scope and spirit of the present disclosure as disclosed in the accompanying claims. Accordingly, the technical scope of the present disclosure is not limited to the detailed description of this specification, but should be defined by the claims.

According to some embodiments of the present disclosure, a driving voltage may have an optimal or improved voltage level for an image displayed on a display panel, by sensing a sensing voltage corresponding to a current flowing through a driving voltage line through a voltage detector (or a voltage controller), and adjusting a voltage level of the driving voltage applied to the driving voltage line in real time depending on the sensing voltage.

According to some embodiments of the present disclosure, when the current flowing into the driving voltage line decreases, the voltage level of the driving voltage may be adjusted depending on the decreased current, thereby reducing the unnecessary power consumed in driving the display device.

The electronic or electric devices and/or any other relevant devices or components according to embodiments of the present disclosure described herein (e.g., the various modules and units, such as the comparison unit, the control unit, and the like) may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the example embodiments of the present disclosure.

The foregoing is illustrative of some embodiments of the present disclosure, and is not to be construed as limiting thereof. Although some embodiments have been described, those skilled in the art will readily appreciate that various modifications are possible in the embodiments without departing from the spirit and scope of the present disclosure. It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Therefore, it is to be understood that the foregoing is illustrative of various example embodiments and is not to be construed as limited to the specific embodiments disclosed herein, and that various modifications to the disclosed embodiments, as well as other example embodiments, are intended to be included within the spirit and scope of the present disclosure as defined in the appended claims, and their equivalents.

What is claimed is:

1. A display device comprising:
a display panel comprising a pixel configured to receive a driving voltage through a driving voltage line;
a panel driver configured to drive the display panel;
a voltage generator configured to generate the driving voltage, and determine a voltage level of the driving voltage based on a voltage control signal;
a driving controller configured to control a driving of the panel driver, and supply the voltage control signal to the voltage generator; and
a voltage detector between the voltage generator and the driving voltage line, and configured to sense a sensing voltage corresponding to a current flowing into the driving voltage line, and output a sensing signal based on the sensing voltage,
wherein the driving controller is configured to:
receive the sensing signal from the voltage detector; and
generate the voltage control signal based on the sensing signal.

2. The display device of claim 1, wherein the driving controller comprises:
a comparator configured to select a reference driving voltage corresponding to the sensing signal from a look-up table configured to store a plurality of reference driving voltages corresponding to a plurality of reference signals, respectively; and
a controller configured to adjust the voltage control signal to control the driving voltage to have a voltage level corresponding to the reference driving voltage.

3. The display device of claim 2, wherein the voltage detector comprises:
a detection circuit comprising a sensing resistor connected between the voltage generator and the driving voltage line;
an amplification circuit connected to a first end of the sensing resistor and a second end of the sensing resistor, and configured to output an output voltage by amplifying a sensing voltage sensed through the first end;
a gain control circuit configured to control a gain of the amplification circuit; and
a conversion circuit configured to receive the output voltage from the amplification circuit, and convert the output voltage into the sensing signal.

4. The display device of claim 3, wherein the amplification circuit comprises:
an operational amplifier comprising a first terminal connected to the first end, and a second terminal connected to the second end; and
a transistor comprising an input electrode connected to the first end, a control electrode connected to an output terminal of the operational amplifier, and an output electrode connected to an output terminal of the amplification circuit.

5. The display device of claim 4, wherein the gain control circuit comprises a gain adjustment resistor connected between the output terminal of the amplification circuit and a ground terminal configured to receive a ground voltage.

6. The display device of claim 4, wherein the gain control circuit is configured to:
receive a gain control signal from the driving controller; and
control the gain of the amplification circuit in response to the gain control signal.

7. The display device of claim 3, wherein the conversion circuit comprises an analog-to-digital converter configured to convert the output voltage into the sensing signal as a digital signal, and
wherein the comparator is configured to receive the sensing signal from the conversion circuit.

8. The display device of claim 2, wherein the voltage control signal is a square wave signal, and
wherein the controller is configured to adjust a duty ratio of the voltage control signal to control the driving voltage to have a voltage level corresponding to the reference driving voltage.

9. The display device of claim 1, wherein the driving voltage line comprises a first driving voltage line and a second driving voltage line, and
wherein the pixel comprises:
a driving transistor connected to the first driving voltage line configured to receive a first driving voltage; and
a light emitting element connected between the driving transistor and the second driving voltage line configured to receive a second driving voltage.

10. The display device of claim 9, wherein the voltage detector is connected between the voltage generator and the second driving voltage line as the driving voltage line.

11. A display device comprising:
a display panel comprising a pixel configured to receive a driving voltage through a driving voltage line;
a panel driver configured to drive the display panel;
a voltage generator configured to generate the driving voltage, and determine a voltage level of the driving voltage based on a voltage control signal;
a driving controller configured to control a driving of the panel driver; and
a voltage controller between the voltage generator and the driving voltage line, and configured to sense a sensing voltage corresponding to a current flowing into the driving voltage line, and generate the voltage control signal based on the sensing voltage.

12. The display device of claim 11, wherein the voltage controller comprises:
a detection circuit comprising a sensing resistor connected between the voltage generator and the driving voltage line;
an amplification circuit connected to a first end of the sensing resistor and a second end of the sensing resistor, and configured to amplify a sensing voltage sensed through the first end into an amplification sensing voltage;
a gain control circuit configured to control a gain of the amplification circuit;
a conversion circuit configured to convert the amplification sensing voltage into a sensing signal; and
a controller configured to:
receive the sensing signal;
select a reference driving voltage corresponding to the sensing signal from a look-up table configured to store a plurality of reference driving voltages corresponding to a plurality of reference signals, respectively; and
adjust the voltage control signal to control the driving voltage to have a voltage level corresponding to the reference driving voltage.

13. The display device of claim 12, wherein the conversion circuit and the controller are embedded together in a voltage control chip.

14. The display device of claim 12, wherein the amplification circuit comprises:
an operational amplifier comprising a first input terminal connected to the first end, and a second input terminal connected to the second end; and
a transistor comprising an input electrode connected to the first end, a control electrode connected to an output end of the operational amplifier, and an output electrode connected to an output end of the amplification circuit.

15. The display device of claim 14, wherein the gain control circuit comprises a resistor connected between the output end of the amplification circuit and a ground end configured to receive a ground voltage.

16. The display device of claim 14, wherein the gain control circuit is configured to:
receive a gain control signal from the driving controller; and
control the gain of the amplification circuit in response to the gain control signal.

17. The display device of claim 12, wherein the conversion circuit comprises an analog-to-digital converter configured to convert the amplification sensing voltage into the sensing signal as a digital signal, and
wherein the controller is configured to receive the sensing signal from the conversion circuit.

18. The display device of claim 12, wherein the voltage control signal is a square wave signal, and
wherein the controller is configured to adjust a duty ratio of the voltage control signal to control the driving voltage to have a voltage level corresponding to the reference driving voltage.

19. The display device of claim 11, wherein the driving voltage line comprises a first driving voltage line and a second driving voltage line,
wherein the pixel comprises:
a driving transistor connected to the first driving voltage line configured to receive a first driving voltage; and
a light emitting element connected between the driving transistor and the second driving voltage line configured to receive a second driving voltage,
wherein the driving voltage is one of the first driving voltage or the second driving voltage, and
wherein the voltage controller is connected between the voltage generator and the second driving voltage line.

20. An electronic device comprising:
a display panel comprising a pixel configured to receive a driving voltage through a driving voltage line;
a panel driver configured to drive the display panel;
a voltage generator configured to generate the driving voltage, and determine a voltage level of the driving voltage based on a voltage control signal;
a driving controller configured to control a driving of the panel driver, and supply the voltage control signal to the voltage generator;
a voltage detector between the voltage generator and the driving voltage line, and configured to sense a sensing voltage corresponding to a current flowing into the driving voltage line, and output a sensing signal based on the sensing voltage; and
a main processor configured to provide an image signal to the driving controller,
wherein the driving controller is configured to:
receive the sensing signal from the voltage detector; and
generate the voltage control signal based on the sensing signal.
